(19) United States
(12) Patent Application Publication
(10) Pub. No.: US 2014/0304009 A1
(43) Pub. Date: Oct. 9, 2014

(54) SYSTEM AND METHOD FOR MANAGEMENT OF INSURABLE ASSETS

(71) Applicant: Contents Control Corporation, Oakdale, MN (US)

(72) Inventors: Jack Saxon, Eagan, MN (US); Donald Raleigh, Blaine, MN (US)

(21) Appl. No.: 14/245,204

(22) Filed: Apr. 4, 2014

Related U.S. Application Data
(60) Provisional application No. 61/808,542, filed on Apr. 4, 2013.

(51) Int. Cl. G06Q 40/08

(52) U.S. Cl. CPC G06Q 40/08
USPC 705/4

(57) ABSTRACT

Systems and methods for managing insurable assets in a multi-party process. An insurable asset management system includes a data store, in which one or more data structures are stored. Each data structure represents assets for a corresponding location and a corresponding client account. The system further includes hardware comprising a processor-based computing system and a set of instructions executable by the system hardware and stored in a non-transitory storage medium that facilitates access to the data structure for clients, delegatees, and insurers.

### RELATED APPLICATION

The present application claims the benefit of U.S. Provisional Application No. 61/808,542 filed Apr. 4, 2013, which is incorporated by reference herein in its entirety.

### TECHNICAL FIELD

The invention relates generally to information processing and related technologies and, more particularly, to systems and methods for inventorying and valuating insurable assets in a scalable, secure and verifiable multi-party process.

### BACKGROUND

Personal property, such as contents of a home or office, can be insured against loss, but when a loss occurs there are a number of practical challenges in ascertaining the value of the insurance payout. For example, on the one hand, the insurer needs proof that the claimed assets were owned by the insured party, that they were present in the claimed location of the loss, and that the claimed value of each asset is accurate. On the other hand, the insured party needs a way to prove the loss, and obtain a proper recovery amount.

A number of computer-based systems for compiling an inventory of assets to be used in connection with insuring those assets have been proposed. See, for example, U.S. Pat. No. 8,219,558; U.S. Pub. No. 2012/0116820; U.S. Pub. No. 2012/0037700, U.S. Pub. No. 2006/0178902, and www.knowyourstuff.org. Various approaches provide tools for capturing photographs, video, and related evidence of insurable assets, and databases for storing this information in an organized and secure fashion.

Though these types of approaches offer useful tools for collecting asset inventory data and, in some cases, securing that data against tampering, a need remains for insurers to obtain a proper valuation of the assets. At the same time, the insurer and customer each needs the valuation process to be fair and unbiased. Absent a secure and verifiable process, the valuations can become points of contention, and remain susceptible to potentially costly irregularities or fraud. A need exists for a solution to enable a secure and verifiable asset management workflow.

### SUMMARY

In an embodiment, a system for managing one or more insurable assets in a multi-party process between a client, a delegatee, a valuator, and an insurer, wherein the one or more insurable assets are located at at least one client location comprises system hardware comprising a processor-based computing system; a data store comprising at least one data structure corresponding to data related to an asset and a client location; and set of instructions executable by the system hardware and stored in a non-transitory storage medium that, when executed, cause the system hardware to implement: a delegation module configured to track progress of valuating the one or more insurable assets according to a predefined workflow and to notify the client, the delegatee, the valuator, and the insurer when each respectively has access to the data store, an access controller module configured to grant or deny access to the client, the delegatee, the valuator, and the insurer for the data store, according to the predefined workflow, and a tracking module configured to record, to the data store, output from the delegation module, the client, the delegatee, the valuator, and the insurer.

In an embodiment, a method for managing insurable assets of a client between a project manager, a field representative, and a valuator, the method being executable by a computer system that includes management server hardware and a data store, comprises initiating a valuation job by notifying the project manager of the valuation job; receiving, by the computer system, and in response to the initiating, project manager input data related to the valuation job from the project manager, the project manager input data including identification of the field representative for the valuation job; authorizing, by the computer system, and in response to the receiving, the field representative to gather data related to the valuation job and denying access to the data store for the valuation job to all other users other than the field representative; receiving, by the computer system, and in response to the authorizing, asset data for the valuation job from the field representative and storing the asset data in the data store; notifying, by the computer system, and in response to the receiving asset data, the project manager that the asset data has been recorded; authorizing, by the computer system, and in response to the notifying the project manager, the project manager to read and edit the asset data and denying access to the data store for the valuation job to all other users other than the project manager; notifying, by the computer system, and in response to the authorizing the project manager, the valuator that the valuation job is ready for valuation; authorizing, by the computer system, and in response to the notifying the valuator, the valuator to read and edit the asset data and denying access to the data store for the valuation job to all other users other than the valuator; receiving, by the computer system, and in response to the authorizing the valuator, valuation data for the asset data and storing the valuation data in the data store; receiving, by the computer system, and in response to the receiving valuation data, an indication that the valuation job is complete from the valuator; and denying, by the computer system, and in response to the receiving the indication, access to all users to the data store for the valuation job.

In certain embodiments, a method for managing insurable assets further comprises notifying, by the computer system, and in response to the denying, the client that the valuation job is complete; and creating, by the computer system, and in response to the notifying the client, a system account for the client and granting read-only access to the client to the data store for the valuation job.

In certain embodiments, a method for managing insurable assets further comprises optionally granting read access, by the computer system, to an insurer for the data store for the valuation job.

In certain embodiments, a method for managing insurable assets further comprises receiving, by the computer system, insurance-related data related to the valuation job from the insurer.

In an embodiment, a method for managing insurable assets of a client between a project manager, a field representative, and a valuator, the method being executable by a computer system that includes management server hardware and a data store comprises means for initiating a valuation job by notifying the project manager of the valuation job; means for receiving, in response to the initiating, project manager input data related to the valuation job from the project manager, the project manager input data including identification of the field representative for the valuation job; means for authorizing, in response to the receiving, the field representative to gather data related to the valuation job and denying access to the data store for the valuation job to all other users other than the field representative; means for receiving, in response to the authorizing, asset data for the valuation job from the field representative and storing the asset data in the data store; means for notifying, in response to the receiving asset data, the project manager that the asset data has been recorded; means for authorizing, in response to the notifying the project manager, the project manager to read and edit the asset data and denying access to the data store for the valuation job to all other users other than the project manager; means for notifying, in response to the authorizing the project manager, the valuator that the valuation job is ready for valuation; means for authorizing, in response to the notifying the valuator, the valuator to read and edit the asset data and denying access to the data store for the valuation job to all other users other than the valuator; means for receiving, in response to the authorizing the valuator, valuation data for the asset data and storing the valuation data in the data store; means for receiving, in response to the receiving valuation data, an indication that the valuation job is complete from the valuator; and means for denying, in response to the receiving the indication, access to all users to the data store for the valuation job.

According to a feature and advantage of certain embodiments, systems and methods facilitate providing insurers and customers a credible valuation of assets. Insurable asset management systems and methods implemented by the insurable asset management systems, according to embodiments, facilitates the passing of permissions to the appropriate parties in order to obtain valuation by a disinterested third party. For example, as described in detail below, a relative handshaking or permission passing between system modules such as a project manager, dispatcher, and valuator, among other modules, allows the right parties to access the right components of the valuation system at the right time.

### BRIEF DESCRIPTION OF THE DRAWINGS

The invention can be completely understood in consideration of the following detailed description of various embodiments of the invention in connection with the accompanying drawings, in which:

FIG. 1 is a block diagram of an insurable asset management system and interfacing elements, according to an embodiment of the invention.

FIG. 2 is a block diagram of an insurable asset management system, according to an embodiment of the invention.

FIG. 3A is a block diagram of a system provider group depicting hierarchical relationships between users of the system provider group, according to an embodiment of the invention.

FIG. 3B is a block diagram of a delegatee group depicting hierarchical relationships between users of the delegatee group, according to an embodiment of the invention.

FIG. 3C is a block diagram of a client group depicting hierarchical relationships between users of the client group, according to an embodiment of the invention.

FIG. 4 is a flowchart of a method for managing insurable assets, according to an embodiment of the invention.

FIG. 5 is a schematic diagram of a computer system for use with a system for managing insurable assets, according to an embodiment of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

One aspect of the invention is directed to a system for managing insurable assets in a multi-party process. In the present context, insurable assets are items of personal property, i.e., chattels, the casualty loss of which can be covered by an insurance policy such as a homeowner's or business owner's policy. Typically, such items can be furniture, appliances, equipment, artwork, décor, etc. The management of the insurable assets relates to establishing the existence and location (i.e., inventory) of each asset or group of assets, establishing the insured value of each asset, and tracking any changes to these, and other, attributes relating to each asset. A multi-party process in the present context relates to facilitating access to the managed insurable asset data to various distinct parties that each plays a specific role in the management.

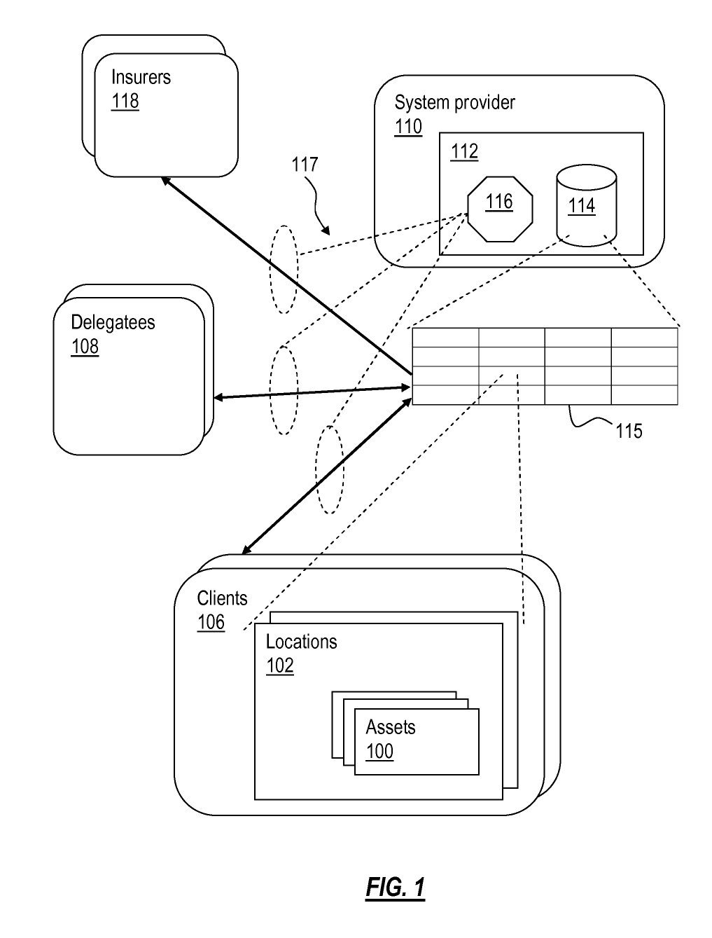

FIG. 1 is a block diagram illustrating an exemplary usage scenario for an insurable asset management system according to one embodiment. Assets 100 are located at each of various locations 102. Locations 102 can be homes, offices, industrial locations, etc. Each location 102 represents a site where assets 100 are located. Each of clients 106 can have a plurality of locations. Delegatees 108 are authorized to establish and update client accounts. Each delegatee 108 can be associated with a plurality of different clients 106. In general, delegatees 108 will have a contractual relationship with clients 106.

System provider 110 operates and makes available asset management system 112. Various types of business models are contemplated in which system provider 110 can make asset management system 112 available for use to benefit clients 106. For instance, delegatees 108 may be third parties who are licensed by system provider 110 to use system 112. Delegatees 108 may be agents of a sub-licensee who is licensed by a direct licensee of system provider 110 to use system 112. In another approach, delegatees 108 are agents of system provider 110.

Insurers 118 are parties who underwrite the insurance policies for clients 106. It is contemplated in one embodiment that insurers 118 are distinct entities from system provider 110 and delegatees 108. In other embodiments, there may be some overlap between these entities. For example, one or more insurers can also be a system administrator. System administrator may be an agent of an insurer 118, or vice-versa. Similarly, delegatees 108 may be agents of one or more insurers 118. They may be sales agents, adjusters, or have some other role.

Aspects of the invention can support any of these, and other, business models. However, for the sake of brevity in this description, delegatees 108, system provider 110, and insurers 118 will be treated as separate entities that have arms-length business arrangements among one another.

As depicted in FIG. 1, insurable asset management system 112 includes data store 114, in which one or more data structures 115 are stored. Each data structure 115 represents assets 100 for corresponding location 102 and corresponding client account 106. System 112 also facilitates access to data structure 115 for clients 106, delegatees 108, and insurers 118. In one type of embodiment, each of these parties is given access to data structure 115 according to an appropriate stage in the workflow for each job. This access is controlled by access controller 116. As depicted, access rights 117 are selectively granted for the appropriate party. In a related embodiment, access history, particularly change history, is tracked for each party. This type of arrangement provides a secure and verifiable history for each record of assets 100.

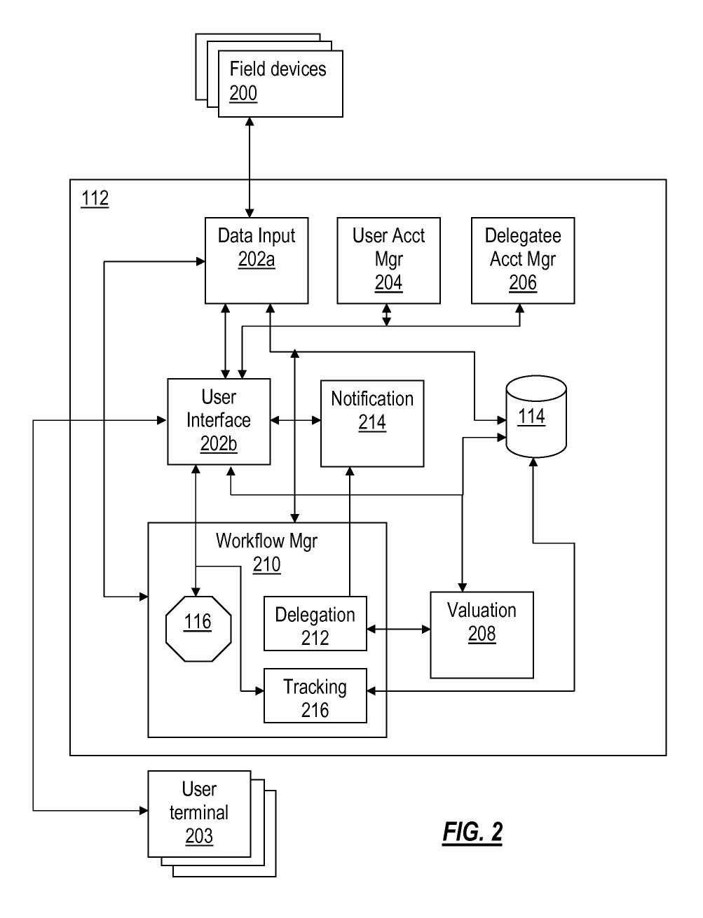

FIG. 2 is a block diagram illustrating asset management system 112 in greater detail according to one embodiment. System 112 is implemented utilizing a computer system on which various functional modules are realized. The computer system can be one physical machine, or can be distributed among multiple physical machines, such as by role or function, or by process thread in the case of a cloud computing distributed model. In various embodiments, system 112 can be configured to run in virtual machines that in turn are executed on one or more physical machines. It will be understood by persons of skill in the art that features of the invention may be realized by a variety of different suitable machine implementations.

The term “module” as used herein means a real-world device, component, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module can also be implemented as a combination of the two, with certain functions facilitated by hardware alone, and other functions facilitated by a combination of hardware and software. In certain implementations, at least a portion, and in some cases, all, of a module can be executed on the processor(s) of one or more general purpose computers (such as the one described in greater detail below) that execute an operating system, system programs, and application programs, while also implementing the module using multitasking, multithreading, distributed (e.g., cloud) processing, or other such techniques. Accordingly, each module can be realized in a variety of suitable configurations, and should not be limited to any particular implementation exemplified herein.

In the embodiment depicted in FIG. 2, field devices 200 are utilized to collect data on locations 102 and insurable assets 100. The field devices, according to one type of embodiment, are portable computing devices such as smartphones or tablets, notebook personal computers, or the like, having a user interface and capability to capture or receive photographic or video images. In a related embodiment, field devices 200 each includes specialized software facilitating data security, dedicated usability of the devices limited to use with system 112, specialized secure communications with system 112 that provides data synchronization with related information stored in data store 114, and off-line data entry and review capabilities. In one approach, field devices 200 are deployed to field representatives of delegatees 108.

In a related embodiment, data entry of asset information is supported by one or more data structures with the following fields to represent various attributes of each asset:
Photos (Multiple uploads available for different angles)
Description
Make
Model
Serial #
Barcode
Category/Sub Category
Quantity
Notes
Room/Location (Of item)
   Size (Width/Height/Depth)
Color
Condition (Numeric scale to keep a standard for multiple Field Representatives)
Independent Insurance Policy (Policy #, contact #, start and end dates of policy)

Field devices 200 each interfaces with system 112 via data input module 202a. In one embodiment, data input module 202a provides an automated, secure, communication channel, e.g., virtual private network or the like, that includes authentication and encryption. In a related embodiment, data input module 202a facilitates synchronization of data for specified jobs containing related assets with data store 114. This feature allows off-line operations with field devices 200, and subsequent transmission of data to system 112 when a job is ready to be uploaded into system 112. In a related embodiment, data input 202a also provides a data input process for accepting data via an interactive user interface.

User interface module 202b is designed to conduct communications with various system users, human operators, or automated agents, via user terminals 203. In one embodiment, user interface module 202b comprises a Web server. In a related embodiment, user interface 202b includes support for facilitating the importation of data regarding assets that was described above as communicated via data input 202a. This functionality may be in addition to data input 202a, or in lieu of data input 202a. In one such embodiment, system 112 supports alternative asset data formats and collection modalities. Thus, for instance, data can be provided to the system via field devices 200, or via user interface 202b using a file upload service, or using an interactive (e.g., Web-based) form, which then feeds the inputted data to data input module 202a.

As will be described in greater detail below, system 112 supports a variety of different users, each of which can perform a particular role in the system workflow. To this end, user account manager module 204 maintains user accounts for each registered user, and handles user authentication and related operations. Users can be authorized individuals from clients 106, delegatees 108, insurers 118, and agents of system provider 110.

Delegatee account manager module 206 manages delegatees 108 who are licensees of the administrator of system 112. Delegatees 108 can be direct licensees, or sub-licensees of direct licensees or higher-tier sub-licensees. Certain licensees have the right to grant sub-licenses, whereas others do not have the right to grant sub-licenses. Accordingly, delegatee account manager module 206 handles storing status or configuration parameters for each delegatee, and for enforcing any limitations placed on certain delegatees.

Valuation module 208 provides an interface and related tools for facilitating valuation of individual assets. As will be described in greater detail below, some embodiments facilitate a workflow in which the valuation is performed by a neutral third party valuator who is to be trusted by insurers 118 and clients 106, and who is not subject to influence of either side. In one such approach, the valuator acts as an agent of system provider 110; thus, the valuator's interests lie in upholding the credibility of system 112 and the underlying business process. Accordingly, valuation module 208 facilitates an interactive valuation process via user interface 202b through which an assigned valuator can review the various assets 100 and assign values, along with the bases used to arrive at those values. In a related embodiment, valuation module 208 facilitates supervisory review of the valuator, including providing a supervisor's interface for reviewing and scoring a valuator's work product and tracking other performance measures. In another related embodiment, valuation module 208 includes a valuation adjustment tool, such as an automated process for entering periodic corrections to the valuation to account for inflation or other economic factors.

Workflow manager module 210 is adapted to coordinate data entry, updates, reviews, corrections, reports, and other tasks among the various parties involved in establishing, executing, valuating, approving, etc., of a job. Workflow manager module 210 includes delegation module 212, which tracks the progress in the workflow as a job is established and executed, and notifies the appropriate party when an action is needed from them via notification module 214. Importantly, in this embodiment, workflow manager module 210 also includes access controller module 116, which adjusts the access permissions correspondingly to match the present needs of the workflow and to lock out all parties except the one to whom the next action for each job is assigned. Tracking module 216 logs access, data entry, and data adjustment history and stores these events as part of the records in data store 114. This tracked data establishes a record of the complete chain of control over each item of the asset information managed by system 112.

In a related embodiment, additional modules are present in system 112, though not shown in the example of FIG. 2. These modules relate to revenue management functionality, i.e., licensing fee billing, subscription billing, use-based billing, etc. Also, other modules that facilitate reporting and other management functionality are present in practical embodiments.

Using system 112, three classes of users participate in, or benefit from, the service provided:

The system provider group manages delegatees, runs reports and is responsible for maintaining and controlling the content. A number of different functional users for the system provider group are supported as well.

The delegatee group, e.g., licensees/sub-licensees purchases subscriptions from the system provider to use the system for providing this inventory management service to their clients (from among the client group), while being able to give their customers up-to-date content reports. A number of different functional users for the delegatee group are supported.

The client group will use system 112 to manage their asset inventory, whether it is home or business (Campus, Building, Floor, Office). For each client, there can be a plurality of authorized users.

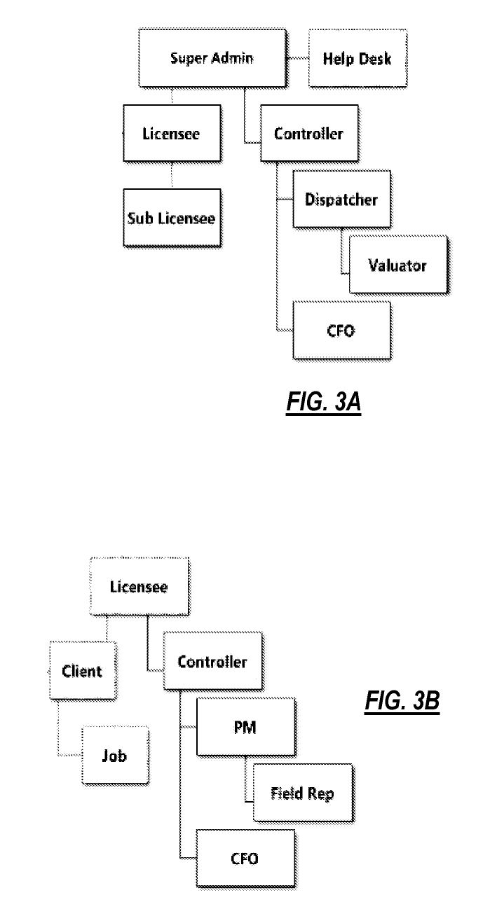

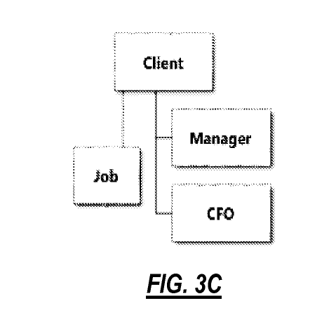

FIGS. 3A-3C are block diagrams illustrating the various functional users for each group, and their hierarchical relationships according to one embodiment. FIG. 3A illustrates the system provider group. In this group, each of the following functional users has corresponding responsibilities and access privileges:

Super Admin (System Provider Group)
Create/Edit/Delete/Suspend Controller
Create/Edit/Delete/Suspend Dispatcher
Create/Edit/Delete/Suspend Valuator
Create/Edit/Delete/Suspend CFO
Create/Edit/Delete/Suspend Licensee
Create/Edit/Delete/Suspend Sub-Licensee
Create/Edit/Delete/Suspend Manager
Create/Edit/Delete/Suspend PM
Create/Edit/Delete/Suspend Field Rep
Create/Edit/Delete/Suspend Client
Create/Edit/Archive/Move/Delete Jobs
Run Reports
   Create the Master Report for a client and send to the Licensee and Client via e-mail and PDF
   View the productivity reports for Valuators
   View profitability of Licensees/Sub-Licensees
   All other reports
Update Global consumer price index (CPI)
Create Invoices
Pay Invoices (For the Client) and manage the invoices

Help Desk/CSR (System Provider Group)
Nearly the same access privilege as the Super Admin, but not to the financial reports or the Mater Report

Controller (System Provider Group)
Create/Edit/Delete/Suspend Dispatcher
Create/Edit/Delete/Suspend CFO
Create/Edit/Delete/Suspend Valuator
Create/Edit/Archive Jobs
Run Reports
Create Invoices
Pay Invoices (For a Client) and manage the invoices

Dispatcher (System Provider Group)
Receive jobs from a project manager (PM) of the Licensee group
Assign jobs to a valuator
Run reports on status of jobs (All)
Reassign jobs to different valuators when needed
Approve jobs and send to Super Admin

Valuator (System Provider Group)
Receive jobs from the Dispatcher
Assign values to assets
Send valued jobs back to the Dispatcher
Approve jobs and send to Super Admin (related embodiment)
Run reports on status of their own jobs

CFO (System Provider Group)
Run Reports
Pay bills
See Payment History

The Licensee and Sub-licensee blocks in FIG. 3A represent a type of user account that is subject to being created, edited, deleted, or suspended by Super Admin. Also, Super Admin is able to log in as a Licensee or Sub-licensee. Also, all billing functions are be tracked. This ensures that a licensee or sub-licensee cannot add new clients or jobs without creating a payment obligation to a superior based on the license agreement, where applicable. Also, the Super Admin is able to move a Sub-licensee to a different Licensee, and to promote a Sub-Licensee to a Licensee.

FIG. 3B illustrates the delegatee group. In this example, the delegatee is a licensee, though a sub-licensee can have a similar hierarchical arrangement of user functions. The following responsibilities and access privileges are provided.

Licensee (Delegatee Group)
Create/Edit/Delete/Suspend Controller
Create/Edit/Delete/Suspend PM
Create/Edit/Delete/Suspend CFO
Create/Edit/Delete/Suspend Field Rep
Create/Edit/Delete/Suspend Client
Create/Edit/Archive/Move/Delete Jobs
Run Reports
Create Invoices
Pay Invoices (For themselves and the Client) and manage the invoices
Create special contact form to request a Sub-License.

Controller (Delegatee Group)
Create/Edit/Delete/Suspend PM
Create/Edit/Delete/Suspend CFO
Create/Edit/Delete/Suspend Field Rep
Create/Edit/Delete/Suspend Client
Create/Edit/Archive Jobs
Run Reports
Create Invoices
Pay Invoices (For themselves and the Client) and manage the invoices

Project Manager (PM) (Delegatee Group)
Create/Edit/Delete/Suspend Field Reps
Create/Edit/Delete/Suspend Clients
Create/Edit/Archive Jobs
Change status of jobs
Assign jobs to Field Reps
Run Reports
Forward jobs to dispatcher
Invoice Management (create, Pay and change status) for a client

Field Rep (Delegatee Group)
Download/Upload jobs via data input module 202a
Work on jobs via user interface module 202b (PM will need to change the status of the job if the Field Rep had already downloaded the job to a field device 200, in which case the job is checked out and normally locked from being accessible though user interface module 202b)
View status of jobs that have been assigned to them

CFO (Delegatee Group)
Run Reports
Pay bills
View Payment History

In this embodiment, the client account can be created, edited, deleted, or suspended by Licensee, Controller, or the PM. The client account can be moved to another licensee by the system provider group. An invoice creator module in some embodiments can generate bills for the client to pay.

Jobs are objects, e.g., in the form of data structures, that can be created by the Licensee, Controller or PM. The status of jobs through the workflow can be set to Loss, Move, or Archive by these users. In the workflow, jobs are assigned by the PM to the Field Rep, who is able to downloaded and upload the jobs from or to data store 114. Jobs can be assigned to the Dispatcher by the Controller or PM for subsequent assignment to a valuator for the assets to be valuated. In one embodiment, jobs can only be deleted by the Licensee.

FIG. 3C illustrates the users of the client group. Their responsibilities and corresponding access privileges are as follows:

Client (Client Group)
Create/Edit/Delete/Suspend a manager
   Assign/Remove manager to/from specific jobs
Create/Edit/Delete/Suspend a CFO
   Assign/Remove CFO to/from specific jobs
Edit jobs
Request action on a job: Loss, Move, Archive
Request a new job
Pay bills
View payment history
Run reports
Get system support (e.g., Help Desk, knowledge base, videos, other training)
Request a Field Rep visit
Submit a Valuation Dispute Request
Request Job Cancellation/Subscription Cancellation
Add a new Asset to a job
   Add an asset and pictures via user interface module 202b
   Optionally, add or modify attributes of an asset
Update existing asset
   Change the asset's location
   Set status as Archive
   Mark as Loss
   Update Attributes (but not valuation)
   Add new picture
   View CPI report

Manager (Client Group)
Create/Edit/Delete/Suspend a CFO
   Assign/Remove CFO to/from specific jobs
Edit jobs
Request action on a job: Loss, Move, Archive
Request a new job
Run reports
Get support (e.g., Help Desk, knowledge base, videos, other Training)
Request a Field Rep visit
Submit a Valuation Dispute Request

CFO
Run Reports
Pay bills
See Payment History
Submit a Valuation Dispute Request

According to various embodiments, the attributes of an asset can be changed by a valuator or a valuator's superiors, e.g., a PM. Depending on the nature of the account, a client may or may not be permitted to set the valuation. For instance, in one embodiment, a client who is a business owner is not permitted to adjust valuation, whereas a client who is a private party, e.g., a homeowner, would be permitted to set or adjust the valuation. This permission largely depends on the nature of the terms of the insurance contract. System 112 is adaptable to assign different permissions on a per-client basis. As discussed above, in one embodiment, any and all entries or updates are tracked and logged.

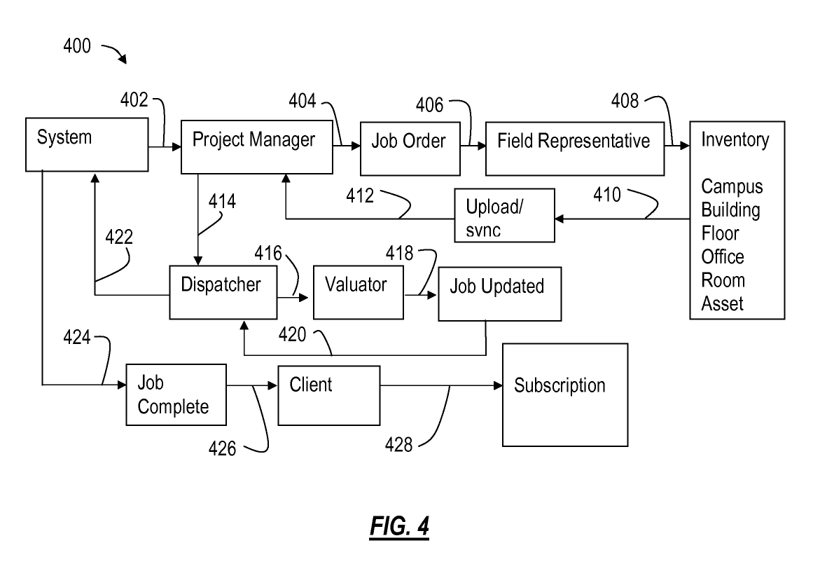

Turning now to FIG. 4, an exemplary workflow 400 is depicted, as facilitated by workflow manager module 210 according to one embodiment. In this example method, system 112 initiates a process for compiling an inventory of assets to be managed for a client by notifying a project manager at 402 to start a job. The project manager can be an agent of a delegate, such as a licensee, or sub-licensee, for example. At 404, the project manager originates a customer account for the client in the system via his or her user account using user interface 202b, and assigns the job order to a field representative at 406. In this example, the following information is associated with the newly-created job order:
Delegatee/Licensee/Sub-licensee
Asset Owner/Client
Job Order Address
Job Order Contact
Job Order Business Name
Job Order Phone #

The job can be associated with a particular location of the client, or can be associated with a particular insurance policy to be purchased from the insurer. Once assigned to the field representative, access controller module 116 prevents other individuals from modifying any data pertaining to the job, and tracks the actions of the field representative. This ensures traceability and creates a reliable chain of control of establishment of the asset information. For example, access controller module 116 can deny access to the data store for the client, valuator, and the insurer upon recognition by delegation module 212 of an authorization for the gathering of asset information.

The field representative visits the client, who may have one or more locations, and gathers information on the assets. In a related aspect of the invention, the field representative has a field device, such as field device 200, which provides a graphical user interface (GUI) that streamlines collecting of asset data. In one approach, the GUI allows the field representative to proceed geographically in a hierarchical fashion, to collect all relevant information. For instance, in the case of a corporate campus that is associated with the current job order, the field representative can proceed building-by-building, floor-by-floor, office-by-office, room-by-room, and asset-by-asset in each room. For each asset, the attributes identified above can be entered. The information can be collected locally on the field device, then uploaded or synchronized to system 112 via data input 202a at 410. At this point, the field representative can be de-authorized by workflow manager 210 from making any further changes to the asset information. Data input module 202a processes the data and stores it in data store 114 using suitable data structures such as those of a relational database system, including integrating the job data with related data pertaining to the client account.

In a related embodiment, multiple field representatives may work on a single job, with each field representative collecting information at a different location in the hierarchy. Modules are provided in data input module 202a to merge each field representative's data, and to reconcile any duplicates or other discrepancy. In this embodiment, access controller module 116 is adapted commensurately to accommodate more than one field representative. In a related embodiment, the project manager is provided controls with which to merge multiple jobs into a single master job.

At 412, workflow manager 210 notifies the project manager via notification module 214, who is given editing privileges so that he or she can review the asset data entered. The project manager can then re-assign the job to the same or a different field representative for further editing or addition of information, in which case access controller module 116 will set access permissions accordingly so that the field representative(s) have exclusive control of information entry or editing.

Once the asset information gathering is complete, the delegatee and all of its agents are de-authorized from adding or editing data by workflow manager module 210. Next, at 414, the system notifies the dispatcher that the job is in a state that is ready for valuation to be performed. At 416, the dispatcher, via his or her user account, assigns the job to a valuator. The system notifies this valuator and grants valuation privileges to the valuator's user account to enable the valuator to add and edit information pertaining to valuation. For example, access controller module 116 can deny access to the data store for the client, the delegatee, and the insurer upon recognition by delegation module 212 that information has been gathered about the insurable assets. In one such approach, the valuator is given privileges to access and modify all of the fields pertaining to the asset. In another approach, the valuator is only given specialized access to view all fields, but to modify or add to only valuation-specific fields.

In one example, the valuator interacts with valuation module 208 via user interface module 202b that presents a valuation-specific GUI to the valuator. One such GUI provides the following fields to the valuator:
Item ID#
Make
Model
Serial #
Active/Inactive
Description
Category/Sub Category
Place Purchased
Date Purchased
Date Sold
Quantity
Photo(s)
Value->Extended
Adjusted Price
   Source for price (Researched sources and results)
      URL
      Comments
      Value Found
Notes
Documentation Attachments (e.g., Receipts)
Bar Code
Depreciation End Date
Room/Location
Size (Height/Width/Depth)
Color
Maintenance Contact (Warranty)
   Expiration
   Point of contact
   Warranty #

The valuator reviews all of the attributes for each asset, and may research the value of the asset in outside sources. The data structure facilitating valuation can store these sources of information, and the results of the valuator's research as bases for the valuation determined by the valuator. Separately, in a related embodiment, tracking module 216 tracks the time and actions taken by the valuator, and stores the tracking information in data store 114 in a suitable data structure associated with the job and, separately, with the valuator's account. These parameters may be used to score the valuator's performance in terms of productivity and thoroughness.

At 418, the valuator indicates completion of the valuation for the job, at which point workflow manager 210 updates the job's status and passes access to the job to the dispatcher at 420, who can review the valuator's work product, and optionally make additions or adjustments. Stages 416-420 can be repeated iteratively. When the valuation process is completed, the dispatcher indicates the completion at 422, and workflow manager module 210 locks out change access to the data pertaining to the job at 424. For example, access controller module 116 can deny access to the data store for the client, the delegatee, and the valuator upon recognition by delegation module 212 that the valuator has communicated an indication that the valuation job is complete.

At 426, the client is notified that the job is completed, and at 428 the system creates a subscription account for the client with view-only access privileges to review and the information and run inventory and asset data reports. In a related embodiment, the client is provided with an option to control the release of asset information to an authorized third party, such as an insurer, who may be given their own account with specified privileges for viewing the asset information as a subset of the client's access rights.

In a related embodiment, the insurer is given additional rights to add and modify insurance-related information that may also be managed by system 112 in association with certain jobs. Such information may include underwriting status, insurance policy parameters, renewal information, premiums, riders, reviews and updates, etc. Additionally, a claims process or claims status update can be supported by system 112. In a related embodiment, a specialized insurance data input similar to data input 102a is provided that interfaces with an insurer's business system and is able to obtain data in various formats (e.g., extensible markup language (XML)), parse and extract relevant data items, and incorporate them in a data structure associated with a client account or job.

In a related embodiment, the client can request addition or updating of assets, asset parameters, or re-valuation of assets, at which point the system can assign the job to the project manager or dispatcher, as appropriate, to review the request and carry out the requested operations.

In a related embodiment, throughout the workflow process, the job can move through various states. For example (not in order):

I. Not Started

II. Incomplete

III. Rejected

IV. Assigned

V. In Progress (Web/Tablet)

VI. Done

VII. Complete

VIII. In Valuation

IX. Valuated

X. Approved

XI. Archived

In a related embodiment, the system provides a process by which various users can transfer, or delegate, their responsibility to another user of an equal or superior access level. Thus, for example, a field rep can transfer a job to another field rep, or a valuator can transfer a job to another valuator. In a related embodiment, each action taken is tracked along with a timestamp, and the transfer or delegation is also tracked with a timestamp. Accordingly, it is possible to determine which individual performed which action.

In another embodiment, there may be different levels of client accounts supported. For instance, a more basic type of client account may require only a subset of the services described above. For example, a private party, i.e., non-business client may not wish to have an independent valuation performed. Accordingly, the valuation process may be omitted. In a variation, the client may be given permission to define his or her own non-independent valuations for the assets.

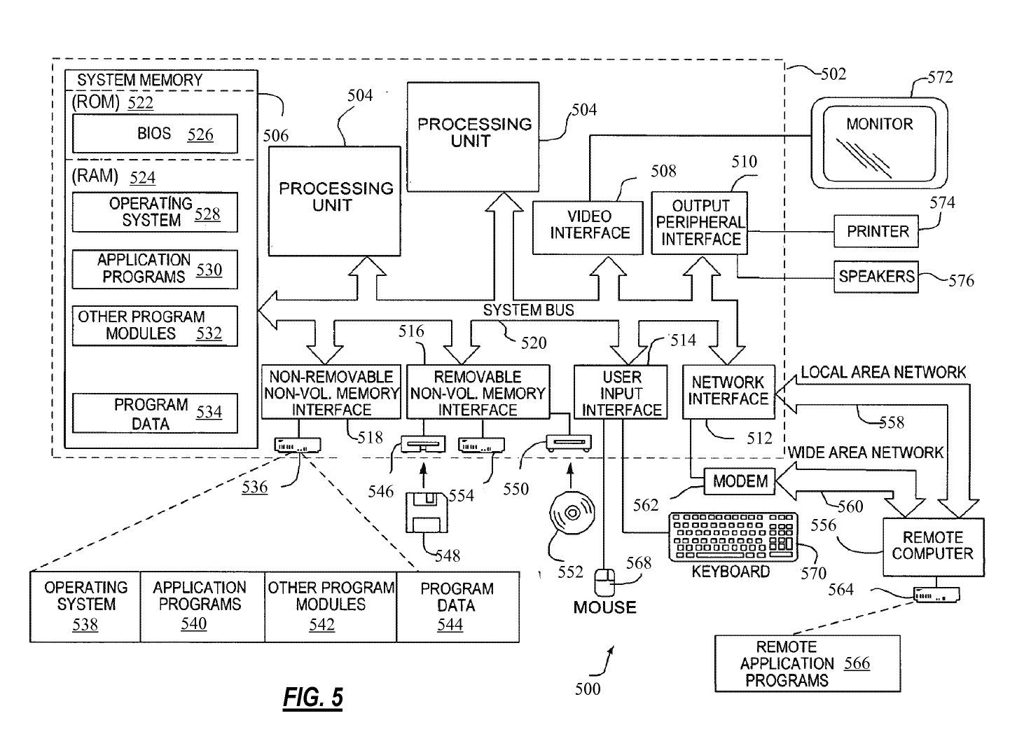

FIG. 5 is a diagram illustrating in greater detail a computer system 500 on which aspects of the invention as described herein may be implemented according to various embodiments. The computer system 500 may include a computing device such as a personal computer 502. The personal computer 502 includes one or more processing units 504, a system memory 506, a video interface 508, an output peripheral interface 510, a network interface 512, a user input interface 514, removable 516 and non-removable 518 memory interfaces and a system bus or high-speed communications channel 520 coupling the various components. In various embodiments, the processing units 504 may have multiple logical cores that are able to process information stored on computer readable media such as the system memory 506 or memory attached to the removable 516 and non-removable 518 memory interfaces 518. The computer 502 system memory 506 may include non-volatile memory such as Read Only Memory (ROM) 522 or volatile memory such as Random Access Memory (RAM) 524. The ROM 522 may include a basic input/output system (BIOS) 526 to help communicate with the other portion of the computer 502. The RAM 524 may store portions of various software applications such as the operating system 528, application programs 530 and other program modules 532. Further, the RAM 524 may store other information such as program or application data 534. In various embodiments, the RAM 524 stores information that requires low-latencies and efficient access, such as programs and data being manipulated or operated on. In various embodiments RAM 524 comprises Double Data Rate (DDR) memory, Error Correcting memory (ECC) or other memory technologies with varying latencies and configurations such as RAMBUS or DDR2 and DDR3. In this way, in various embodiments, the system memory 506 may store the input data store, access credential data store, operating memory data store, instruction set data store, analysis result data store and the operating memory data store. Further, in various embodiments, the processing units 504 may be configured to execute instructions that limit access to the aforementioned data stores by requiring access credential before access to the information is granted.

The removable 516 and non-removable 518 memory interfaces may couple the computer 502 to disk drives 536 such as SSD or rotational disk drives. These disk drives 536 may provide further storage for various software applications such as the operating system 538, application programs 540 and other program modules 542. Further, the disk drives 536 may store other information such as program or application data 544. In various embodiments, the disk drives 536 store information that doesn't require the same low-latencies as in other storage mediums. Further, the operating system 538, application program 540 data, program modules 542 and program or application data 544 may be the same information as that stored in the RAM 524 in various embodiments mentioned above or it may be different data potentially derivative of the RAM 524 stored data.

Further, the removable non-volatile memory interface 516 may couple the computer 502 to magnetic portable disk drives 546 that utilize magnetic media such as the floppy disk 548, Iomega® Zip or Jazz, or optical disk drives 550 that utilize optical media 552 for storage of computer readable media such as Blu-Ray®, DVD-R/RW, CD-R/RW and other similar formats. Still other embodiments utilize SSD or rotational disks housed in portable enclosures to increase the capacity of removable memory.

The computer 502 may utilize the network interface 512 to communicate with one or more remote computers 556 over a local area network (LAN) 558 or a wide area network (WAN) 560. The network interface 512 may utilize a Network Interface Card (NIC) or other interface such as a modem 562 to enable communication. The modem 562 may enable communication over telephone lines, coaxial, fiber optic, powerline, or wirelessly. The remote computer 556 may contain a similar hardware and software configuration or may have a memory 564 that contains remote application programs 566 that may provide additional computer readable instructions to the computer 502. In various embodiments, the remote computer memory 564 can be utilized to store information such as identified file information that may be later downloaded to local system memory 506. Further, in various embodiments the remote computer 556 may be an application server, an administrative server, client computers, or a network appliance.

A user may enter information to the computer 502 using input devices connected to the user input interface 514 such as a mouse 568 and keyboard 570. Additionally, the input device may be a trackpad, fingerprint scanner, joystick, barcode scanner, media scanner or the like. The video interface 508 may provide visual information to a display such as a monitor 572. The video interface 508 may be an embedded interface or it may be a discrete interface. Further, the computer may utilize a plurality of video interfaces 508, network interfaces 512 and removable 516 and non-removable 518 interfaces in order to increase the flexibility in operation of the computer 502. Further, various embodiments utilize several monitors 572 and several video interfaces 508 to vary the performance and capabilities of the computer 502. Other computer interfaces may be included in computer 502 such as the output peripheral interface 510. This interface may be coupled to a printer 574 or speakers 576 or other peripherals to provide additional functionality to the computer 502.

Various alternative configurations and implementations of the computer 502 are within the spirit of the invention. These variations may include, without limitation, additional interfaces coupled to the system bus 520 such as universal serial bus (USB), printer port, game port, PCI bus, PCI Express or integrations of the various components described above into chipset components such as the northbridge or southbridge. For example, in various embodiments, the processing unit 504 may include an embedded memory controller (not shown) to enable more efficient transfer of data from the system memory 506 than the system bus 520 may provide.

The embodiments above are intended to be illustrative and not limiting. In addition, although aspects of the present invention have been described with reference to particular embodiments, those skilled in the art will recognize that changes can be made in form and detail without departing from the scope of the invention.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as will be understood by persons of ordinary skill in the art.

Any incorporation by reference of documents above is limited such that no subject matter is incorporated that is contrary to the explicit disclosure herein. Any incorporation by reference of documents above is further limited such that no claims that are included in the documents are incorporated by reference into the claims of the present application. The claims of any of the documents are, however, incorporated as part of the disclosure herein, unless specifically excluded. Any incorporation by reference of documents above is yet further limited such that any definitions provided in the documents are not incorporated by reference herein unless expressly included herein.

1. A system for managing one or more insurable assets in a multi-party process between a client, a delegatee, a valuator, and an insurer, wherein the one or more insurable assets are located at at least one client location, the system comprising:
system hardware comprising a processor-based computing system;
a data store comprising at least one data structure corresponding to data related to an asset and a client location; and
set of instructions executable by the system hardware and stored in a non-transitory storage medium that, when executed, cause the system hardware to implement:
a delegation module configured to track progress of valuating the one or more insurable assets according to a predefined workflow and to notify the client, the delegatee, the valuator, and the insurer when each respectively has access to the data store,
an access controller module configured to grant or deny access to the client, the delegatee, the valuator, and the insurer for the data store, according to the predefined workflow, and
a tracking module configured to record, to the data store, output from the delegation module, the client, the delegatee, the valuator, and the insurer.

2. The system of claim 1, further comprising at least one field device configured to facilitate collection of data representing a plurality of assets at a client location, wherein the set of instructions executable by system hardware and stored in the non-transitory storage medium further comprises a data input module configured to provide a communication channel between the data store and the at least one field device.

3. The system of claim 1, wherein the set of instructions executable by system hardware and stored in the non-transitory storage medium further comprises a user account manager module configured to maintain at least one user account for the client, user account for the delegatee, user account for the system, or user account for the insurer.

4. The system of claim 3, wherein user account for the system is selected from the group consisting of a super administrator, a help desk user, a controller, a dispatcher, a valuator, and a CFO.

5. The system of claim 3, wherein the user account for the client is selected from the group consisting of a client, a manager, and a CFO.

6. The system of claim 3, wherein the user account for the delegatee is selected from the group consisting of a licensee, a controller, a project manager, a field representative, and a CFO.

7. The system of claim 1, wherein the set of instructions executable by the system hardware and stored in non-transitory storage medium further comprises a delegatee account manager module configured to store status and configuration parameters for each delegate account and to enforce limitations on each delegatee account.

8. The system of claim 1, wherein the set of instructions executable by system hardware and stored in non-transitory storage medium further comprises a valuation module configured to provide an interface and valuation recordation tools to an independent valuator for valuating the one or more insurable assets.

9. The system of claim 1, wherein the access controller is configured to grant access to the data store for the delegatee and deny access to the data store for the client, valuator, and the insurer upon recognition by the delegation module of an authorization for the gathering of information for the one or more insurable assets.

10. The system of claim 1, wherein the access controller is configured to grant access to the data store for the valuator and deny access to the data store for the client, the delegatee, and the insurer upon recognition by the delegation module that information has been gathered about the one or more insurable assets.

11. The system of claim 1, wherein the access controller is configured to grant access to the data store for the insurer and deny access to the data store for the client, the delegatee, and the valuator upon recognition by the delegation module that the valuator has communicated an indication that the valuation job is complete.

12. A method for managing insurable assets of a client between a project manager, a field representative, and a valuator, the method being executable by a computer system that includes management server hardware and a data store, the method comprising:
initiating a valuation job by notifying the project manager of the valuation job;
receiving, by the computer system, and in response to the initiating, project manager input data related to the valuation job from the project manager, the project manager input data including identification of the field representative for the valuation job;
authorizing, by the computer system, and in response to the receiving, the field representative to gather data related to the valuation job and denying access to the data store for the valuation job to all other users other than the field representative;
receiving, by the computer system, and in response to the authorizing, asset data for the valuation job from the field representative and storing the asset data in the data store;
notifying, by the computer system, and in response to the receiving asset data, the project manager that the asset data has been recorded;
authorizing, by the computer system, and in response to the notifying the project manager, the project manager to read and edit the asset data and denying access to the data store for the valuation job to all other users other than the project manager;
notifying, by the computer system, and in response to the authorizing the project manager, the valuator that the valuation job is ready for valuation;
authorizing, by the computer system, and in response to the notifying the valuator, the valuator to read and edit the asset data and denying access to the data store for the valuation job to all other users other than the valuator;
receiving, by the computer system, and in response to the authorizing the valuator, valuation data for the asset data and storing the valuation data in the data store;
receiving, by the computer system, and in response to the receiving valuation data, an indication that the valuation job is complete from the valuator; and
denying, by the computer system, and in response to the receiving the indication, access to all users to the data store for the valuation job.

13. The method of claim 12, further comprising:
notifying, by the computer system, and in response to the denying, the client that the valuation job is complete; and
creating, by the computer system, and in response to the notifying the client, a system account for the client and granting read-only access to the client to the data store for the valuation job.

14. The method of claim 13, further comprising:
optionally granting read access, by the computer system, to an insurer for the data store for the valuation job; and
receiving, by the computer system, insurance-related data related to the valuation job from the insurer.

15. The method of claim 12, wherein a dispatcher is configured to notify the valuator that the valuation job is ready for valuation, wherein the dispatcher is granted read and edit access to the data store for the valuation job after receiving the indication that the valuation job is complete from the valuator.

16. The method of claim 12, further comprising authorizing, by the computer system, a plurality of field representatives to gather data related to the valuation job, wherein the method further comprises receiving, by the computer system, asset data for the valuation job from the plurality of field representatives.

17. The method of claim 12, further comprising:
receiving, by the computer system, reassignment data from the project manager after notifying the project manager that the asset data has been recorded; and
reauthorizing, by the computer system, and in response to the receiving reassignment data, the field representative to re-gather asset data based on the received reassignment data.

18. The method of claim 12, wherein authorizing the valuator to read and edit the asset data comprises granting, by the computer system, read access to non-valuation-specific fields and read and edit access to valuation-specific fields.

19. The method of claim 12, further comprising:
tracking, by the computer system, the duration of access and access transactions made by the valuator; and
evaluating, by the computer system, the valuator based at least on the tracked duration of access and access transactions made by the valuator.

20. The method of claim 12, wherein the project manager is notified of the valuation job by the computer system.

21. The method of claim 12, wherein the project manager is notified of the valuation job by a third party system.

22. A method for managing insurable assets of a client between a project manager, a field representative, and a valuator, the method being executable by a computer system that includes management server hardware and a data store, the method comprising:
means for initiating a valuation job by notifying the project manager of the valuation job;
means for receiving, in response to the initiating, project manager input data related to the valuation job from the project manager, the project manager input data including identification of the field representative for the valuation job;
means for authorizing, in response to the receiving, the field representative to gather data related to the valuation job and denying access to the data store for the valuation job to all other users other than the field representative;
means for receiving, in response to the authorizing, asset data for the valuation job from the field representative and storing the asset data in the data store;
means for notifying, in response to the receiving asset data, the project manager that the asset data has been recorded;
means for authorizing, in response to the notifying the project manager, the project manager to read and edit the asset data and denying access to the data store for the valuation job to all other users other than the project manager;
means for notifying, in response to the authorizing the project manager, the valuator that the valuation job is ready for valuation;
means for authorizing, in response to the notifying the valuator, the valuator to read and edit the asset data and denying access to the data store for the valuation job to all other users other than the valuator;
means for receiving, in response to the authorizing the valuator, valuation data for the asset data and storing the valuation data in the data store;
means for receiving, in response to the receiving valuation data, an indication that the valuation job is complete from the valuator; and
means for denying, in response to the receiving the indication, access to all users to the data store for the valuation job.
